(19) United States
(12) Patent Application Publication
(10) Pub. No.: US 2014/0026076 A1
(43) Pub. Date: Jan. 23, 2014

(54) REAL-TIME INTERACTIVE COLLABORATION SYSTEM

(71) Applicants: Jacquilene Jacob, Yonkers, NY (US); Hock M. Ng, Westfield, NJ (US); Benjamin M. Lowe, Short Hills, NJ (US)

(72) Inventors: Jacquilene Jacob, Yonkers, NY (US); Hock M. Ng, Westfield, NJ (US); Benjamin M. Lowe, Short Hills, NJ (US)

(21) Appl. No.: 13/550,917

(22) Filed: Jul. 17, 2012

(51) Int. Cl. G06F 3/033; G06F 3/048

(52) U.S. Cl. 715/757; 345/158

(57) ABSTRACT

A system and method for real-time interactive collaboration between remote users communicating via one or more input devices adapted to provide alter documents, imagery and the like projected within a multidimensional virtual interactive space.

### FIELD OF THE INVENTION

The invention relates generally to the field of communication networks and, more specifically, to real-time interactive collaboration between remote meeting application users.

### BACKGROUND

In the prior art, applications for meetings with remote participants are disclosed. In some remote meeting applications provide desktop sharing, but only one person controls the view of what is seen by every other participant in the meeting. In other words, there is only a “one-way” sharing of someone's view of the computer desktop. While there are whiteboard application where two remote users can interactively draw on the same “canvas,” such applications provide to users an extremely awkward mechanism to manipulate a mouse or other pointing device when trying to write on the canvas. Moreover, existing whiteboard applications typically allow only two users to collaborate.

As an example, in group meetings a whiteboard is often used to write down ideas for brainstorming, draw schematics, equations, and the like. Existing interactive whiteboards are mounted on a wall and include a writing surface and various control devices for user interaction, such as Infra Red (IR) pens and the like. Unfortunately, existing systems do not allow annotation of streaming videos when connected to remote users. To be annotated, the video is paused and then annotated. In addition, documents in various presentation, spreadsheet, image and other formats cannot be annotated and shared in real-time. Existing systems also require bulky and often significant amounts of hardware and other apparatus.

### SUMMARY

Various deficiencies of the prior art are addressed by systems, methods and apparatus providing real-time interactive collaboration between remote users communicating via one or more input devices adapted to provide alter documents, imagery and the like projected within a virtual interactive space.

One embodiment comprises a system adapted to provide real-time collaborative interaction between a plurality of users, including a presentation arrangement adapted to provide imagery associated with a virtual interactive space; an input device adapted to provide motion indicative signaling within a volume associated with the virtual interactive space; and a processor in communication with the presentation arrangement and the input device, the processor adapted to propagate data representing the imagery toward one or more remote users, to receive data indicative of input device motion within the virtual interactive space, and to adapt the imagery in response to the data indicative of input device motion within the virtual interactive space.

### BRIEF DESCRIPTION OF THE DRAWINGS

The teachings of the present invention can be readily understood by considering the following detailed description in conjunction with the accompanying drawings, in which:

FIG. 1 depicts a high level block diagram of an exemplary Real-time Interactive Collaborative System according to an embodiment;

FIG. 2 depicts a graphical illustration of a whiteboard space according to an embodiment;

FIG. 3 depicts an exemplary Infra Red (IR) Pen according to an embodiment;

FIG. 4 depicts a flow diagram of a method for system calibration and operation according to an embodiment;

FIG. 5 depicts a high level block diagram of an exemplary Real-time Interactive Collaborative System including a Redirect Server according to an embodiment;

FIG. 6 depicts a flow diagram of a method for synchronizing video files according to an embodiment;

FIG. 7 depicts a flow diagram of a method for sharing documents among users with real time annotation;

FIG. 8 depicts a flow diagram of a method for manipulating 3D figures;

FIG. 9 depicts a flow diagram of a method for transforming of Input Device Positions according to an embodiment; and

FIG. 10 depicts a high-level block diagram of a computer suitable for use in performing various functions described herein.

To facilitate understanding, identical reference numerals have been used, where possible, to designate identical elements that are common to the Figures.

### DETAILED DESCRIPTION

The invention will be primarily described within the context of particular embodiments; however, those skilled in the art and informed by the teachings herein will realize that the invention is also applicable to other technical areas and/or embodiments.

Generally speaking, the various embodiments enable, support and/or provide a configuration paradigm enabling multiple users to collaborate in real-time when conducting remote group meetings, such as drawing diagrams, writing mathematical equations, sharing and annotating documents in real-time and the like. Various embodiments operate to provide an alternative away from existing interactive whiteboards, which do not provide a friendlier user interface. The embodiments provide interactive and real-time collaborative remote group meetings. One embodiment allows “virtual” and/or physical whiteboards to be networked such that users in separate remote locations can draw, write and annotate on each others' whiteboard. Digitization is achieved by means of an Infra Red (IR) pen together with one or multiple IR sensors.

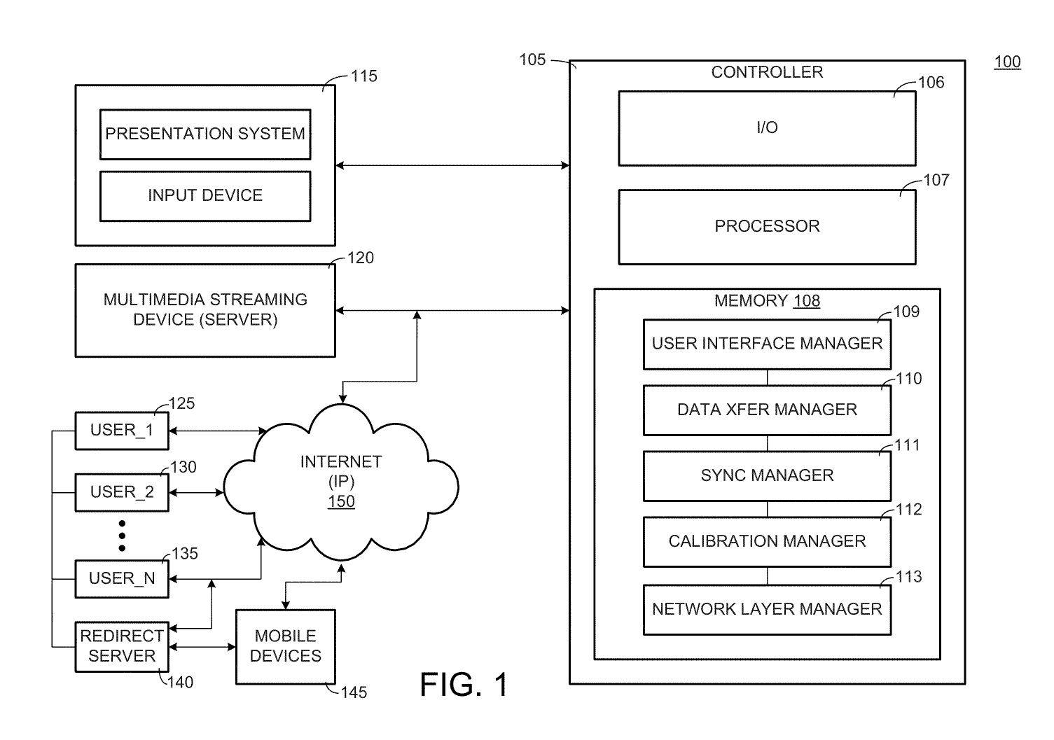

FIG. 1 depicts a high level block diagram of an exemplary Real-time Interactive Collaborative System according to an embodiment. Specifically, FIG. 1 depicts an exemplary Real-time Interactive Collaborative System 100 that includes Controller 105, a presentation system and input device 115, a multimedia streaming device 120, a plurality of users or user devices (UD) 125-145, an IP network (or other network) 150 and a Redirect Server 140.

Real-time Interactive Collaborative System is an exemplary system only; other types of systems may be used within the context of the various embodiments. The basic configuration and operation of the Real-time Interactive Collaborative System will be understood by one skilled in the art as described herein.

In one embodiment, Controller 105 provides a real-time interactive interface to a remote user in a single location on a peer-to-peer basis. In another embodiment, when multiple users in multiple locations are using the system, a client-server arrangement is provided involving a server to perform traffic management. Other permutations are also contemplated.

Presentation system and input device 115 provides a mechanism to set-up a virtual interactive space. The virtual interactive space may comprise a three dimensional space or a two dimensional space. For example, a flat surface, such as a wall, floor, table and the like may be used to provide a two dimensional interaction medium or space which may, in various embodiments, be further associated with a depth parameter to define thereby a volume of space. Two and three dimensional display techniques may be defined in accordance with the teachings herein and further in accordance with improvements in 2D and 3D display technologies.

In various embodiments, imagery presented in a two dimensional space may be virtually manipulated via input device motion within a three-dimensional space proximate the two dimensional space, such as user manipulation of an input device proximate an object presented upon a flat surface.

Generally speaking, the presentation system is adapted to provide imagery associated with a virtual interactive space, while the input devices adapted to provide motion indicative signaling within a volume associated with the virtual interactive space. For example, imagery may be projected upon or displayed upon a flat surface such as a whiteboard by the presentation system, while input device motion in the volume of space proximate the whiteboard is sensed and interpreted by the processor as user manipulation of objects or other portions of the displayed imagery.

Multimedia streaming device 120 provides streaming video and other multimedia content in one embodiment. In other embodiments, other sources of multimedia content are contemplated. For example, the source may comprise independent third party multimedia content providers.

User devices 125-135 and 145 interact collaboratively in real-time with a local user through Controller 105. User devices 145 may be a smart phone, PDA, computer, or any other wireless user device.

In one embodiment, applications on mobile platforms (such as Windows, iPhone/iPad and Android) connect to the whiteboard's IP address to transfer data. In this embodiment, multiple users are connected to the whiteboard from their mobile applications. The mobile device e.g., iPad, iPhone, Android may perform certain functions on the wall. In one embodiment, the mobile device adds and deletes content on the wall.

Mobile devices may be used to provide gesture inputs, such as flipping pages on a whiteboard, inserting a pen stroke and the like in response to a swiping gesture made with a smartphone, tablet or other mobile device. In various embodiments, gestures are captured via an accelerometer, touchpad, on-screen input means and the like. In other embodiments, other functions are contemplated.

In various embodiments, one or more remote users comprise mobile nodes (MNs) wherein at least some of the MNs are enabled to provide gesture input in response to user interaction. The user interaction comprises any of physical motion of the MN, manipulation of a MN touch screen, or manipulation of a MN keyboard. The MN input may be provided via wireless network, such as WiFi, 802.11(x), WiMAX, 3G, 4G, LTE and so on. The MN input device may be used alone or in conjunctions with an IR pen input to help supplement input data. Some or all of the MNs may be enabled to add or delete content on the multidimensional virtual interactive space. Some or all of the MNs may be only modify delete content on the multidimensional virtual interactive space. Various permissions may be used to control the allowed interactions of the various users.

Redirect server 140 acts as a traffic manager when there are multiple users from multiple locations using the system.

IP Network 150 may be implemented using any suitable communications capabilities.

As depicted in FIG. 1, Controller 105 includes I/O circuitry 106, a processor 107, and a memory 108. Processor 107 is adapted to cooperate with memory 108, I/O circuitry 106 to provide various publishing functions for the content publisher.

I/O circuitry 106 is adapted to facilitate communications with peripheral devices both internal and external to processor 107. For example, I/O circuitry 106 is adapted to interface with memory 108. Similarly, I/O circuitry 106 is adapted to facilitate communications with User Interface Manager 109, Data Transfer Manager 110, Sync Manager 111, Calibration Manager 112, Network Layer Manager 113 and the like. In various embodiments, a connection is provided between processor ports and any peripheral devices used to communicate with Controller 105.

In one embodiment, I/O circuitry 106 is adapted to facilitate communications with presentation system and input device 115 as one entity. In another embodiment, I/O circuitry 106 communicates with the presentation system and the input device separately. In this embodiment, the input device is equipped to communicate independently with the computer.

Although primarily depicted and described with respect to User Interface Manager 109, Data Transfer Manager 110, Sync Manager 111, Calibration Manager 112, Network Layer Manager 113, it will be appreciated that I/O circuitry 106 may be adapted to support communications with any other devices suitable for providing the computing services associated with controller 105.

Memory 108, generally speaking, stores data and software programs that are adapted for use in providing various computing functions within the Real-Time Interactive Collaborative system. The memory includes a User Interface Manager 109, Data Transfer Manager 110, Sync Manager 111, Calibration Manager 112, Network Layer Manager 113.

In one embodiment, User Interface Manager 109 is an abstraction layer above Data Transfer Manager 110. User Interface Layer includes the projected surface on a wall or any flat surface with features such as pen color, stroke width, transformations, networking, eraser, document sharing, zoom in/out, stroke editing (e.g., selection and modification) and the like. Data Transfer Layer is an abstraction below the User Interface Layer and above the Network Layer. Data Transfer Layer includes the message and header creation and transfer of the data such as strokes, text, documents, multimedia files and the like. Network Layer provides networking services based on TCP Sockets paradigm. In another embodiment, Network Layer provides interface with Redirect Server 510 enabling multiple user collaboration.

In one embodiment, User Interface Manager 109, Data Transfer Manager 110, Sync Manager 111, Calibration Manager 112, Network Layer Manager 113 are implemented using software instructions which may be executed by processor (e.g., processor 107) for performing the various functionalities depicted and described herein.

Although depicted and described with respect to an embodiment in which each of the engines or manager is stored within memory 108, it will be appreciated by those skilled in the art that the engines/managers may be stored in one or more other storage devices internal to Controller 105 and/or external to Controller 105. The engines/managers may be distributed across any suitable numbers and/or types of storage devices internal and/or external to Controller 105. The memory 108, including each of the engines/managers and tools of memory 108, is described in additional detail herein below.

As described herein, memory 108 includes User Interface Manager 109, Data Transfer Manager 110, Sync Manager 111, Calibration Manager 112 and Network Layer Manager 113, which cooperate to provide the various real-time interactive collaboration functions depicted and described herein. Although primarily depicted and described herein with respect to specific functions being performed by and/or using specific ones of the engines/managers of memory 108, it will be appreciated that any of the real-time interactive collaboration functions depicted and described herein may be performed by and/or using any one or more of the engines of memory 108.

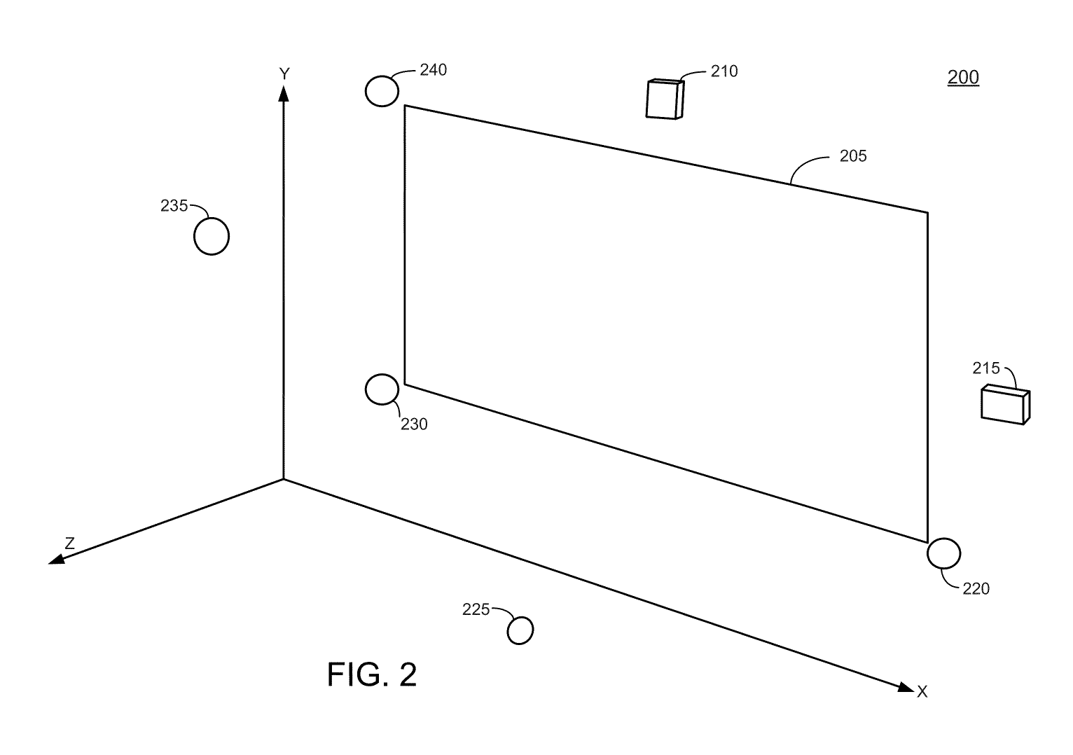

In one embodiment, Calibration Manager 112 performs calibration of the system. System calibration is explained with reference to FIG. 2. In one embodiment, calibration is performed manually. In another embodiment, calibration is performed automatically.

Thus, in various embodiments, a system adapted to provide real-time collaborative interaction between a plurality of users includes a presentation system adapted to provide imagery associated with a virtual interactive space, an input device adapted to provide motion indicative signaling within a volume associated with the virtual interactive space, and a processor in communication with the presentation system and the input device. The processor propagates data representing virtual interactive space imagery toward one or more remote users, and receives data indicative of input device motion within the virtual interactive space from local and/or remote users. The processor adapts the imagery associated with the virtual interactive space in response to the received input device motion data. Specifically, the processor interprets the input device motion data to identify corresponding user manipulation of objects and the like within the presented/displayed imagery. FIG. 2 depicts a graphical illustration of a whiteboard space according to an embodiment. Specifically, FIG. 2 depicts a substantially rectilinear whiteboard space having a two-dimensional or planar parameter defined by three infra-red (IR) light emitting diodes (LEDs) denoted as IR LED 1 (220), IR LED 2 (230), IR LED 3 (240), disposed upon a flat surface (e.g., a wall) at three respective corners.

A three-dimensional or depth parameter defined by fourth and fifth IR LEDs denoted as IR LED 4 (225) and IR LED 5 (235) that are disposed at a distance d away from (i.e., normal to) the flat surface. The distance d may comprise a few inches or a few feet, depending upon a desired size of a virtual interactive space to be provided. The fourth IR LED 225 is depicted as being positioned below the two-dimensional whiteboard space (e.g., mounted to a floor in front of the wall), while the fifth IR LED 235 is depicted as being positioned to the side of the two-dimensional whiteboard space (e.g., mounted to an adjoining wall). The distance d from the flat surface supporting the first three IR LEDs to each of the fourth and fifth IR LEDs may be the same or different.

Two IR sensors; namely, IR sensor 1 (210), IR sensor 2 (215) are disposed about the defined virtual interactive space in a manner adapted to detect motion therein.

In one embodiment, the IR sensor is a remote sensor such as used in various video game system, illustratively the Wii system manufactured by Nintendo, Inc. of Tokyo, Japan Other IR sensors may be used. The Wii remote sensor has an IR sensor array that can track the locations of up to four separate IR points in one embodiment. In another embodiment, there are multiple Wii remote sensors used in order to overcome the shadowing problem (since the IR pen/sensor pair operates in line of sight, the view of the IR spot can be blocked if the person stands in the path between the emitter and the sensor). This allows the user to step up to the “virtual” whiteboard which is a projected image of the computer screen on the wall or any flat surface and start writing with an IR pen. In other embodiments, other types of remote sensors are utilized.

In one embodiment, IR sensor 1 (210), IR sensor 2 (215) read IR coordinates on the x-y plane to draw and manipulate strokes on the wall. In another embodiment, using IR sensor 1 (210), IR sensor 2 (215) a user can draw and manipulate strokes in 3-dimensional space using coordinates in x-y-z plane. This enables the users to plot and draw objects in space and apply transformations such as rotation, scaling and translation in 3-dimensional space. In yet another embodiment, the collaborative portion of the multidimensional interactive virtual space application enables the users to send/transfer strokes to different remote users in remote locations. The users on either ends can interact with each other in both 2-dimensional space (x-y plane) as well as 3-dimensional space (x-y-z) and apply geometric transformations to the objects, which are viewed in real time.

Referring to FIG. 2, in one embodiment, whiteboard 205 projected on a wall is calibrated as a rectangular 2-dimensional x-y space using the three IR points IR LED1 (220), IR LED2 (230) and IR LED3 (240). The IR LED4 (225) and IR LED5 (235) are used to calibrate the 3-dimensional x-y-z space perpendicular to the 2-dimensional x-y space. In one embodiment, IR sensor 1 (210) and IR sensor 2 (215) are placed at right angles to each other for the calibration technique described above. In another embodiment, IR sensor 1 (210) and IR sensor 2 (215) are placed at an optimal distance to x-y plane and x-y-z plane such that the IR sensors can detect the IR points created by an input device, e.g., IR pen, in the rectangular area which is calibrated. For example, the geometry of the room plays a significant role in determining the optimal distance.

This technique of calibration and set up of the collaborative system helps a right-handed or a left-handed user to make continuous and seamless strokes by avoiding blockage of the IR sensors from detecting the IR light made by an IR pen or equivalent.

Referring to FIG. 2, an x-y plane is defined by a wall, and the z-direction is pointing out perpendicular to the wall. The origin is located at the position of IR LED-2 (230). The first step is to calibrate the width and height of the drawing surface. The width is determined from IR sensor 1 (210) reading the positions of IR LED1 (220) and IR LED2 (230). IR LED1 (220) and IR LED2 (230) can be turned on in sequence and the difference in the pixel positions read by IR sensor 1 (210) is mapped to the actual physical distance of IR LED1 (220) and IR LED2 (230). The height is calibrated from IR sensor 2 (215) reading the positions of IR LED2 (230) and IR LED3 (240) in a similar fashion.

The second step is to calibrate the distance in the z-direction. This is performed separately for the x-y plane by reading the positions of IR LED4 (225) and IR LED1 (220) (or IR LED2 (230)) and IR sensor 2 (215) reading the position of IR LED5 (235) and IR LED2 (230) (or IR LED3 (240)). All the reference points are then stored in memory.

Although primarily depicted and described with respect to the embodiment of FIG. 2, it will be appreciated that other arrangements are also contemplated. For example, initially the point of origin is located at IR LED 2 (230); however, in other embodiments the point of origin could be located at any of IR LED 3 (240) or IR LED 1 (220). For example, it will be appreciated that while the various embodiments discussed herein are depicted as using Infra-Red devices, other types of devices and/or other wavelengths may also be used within the context of the various embodiments.

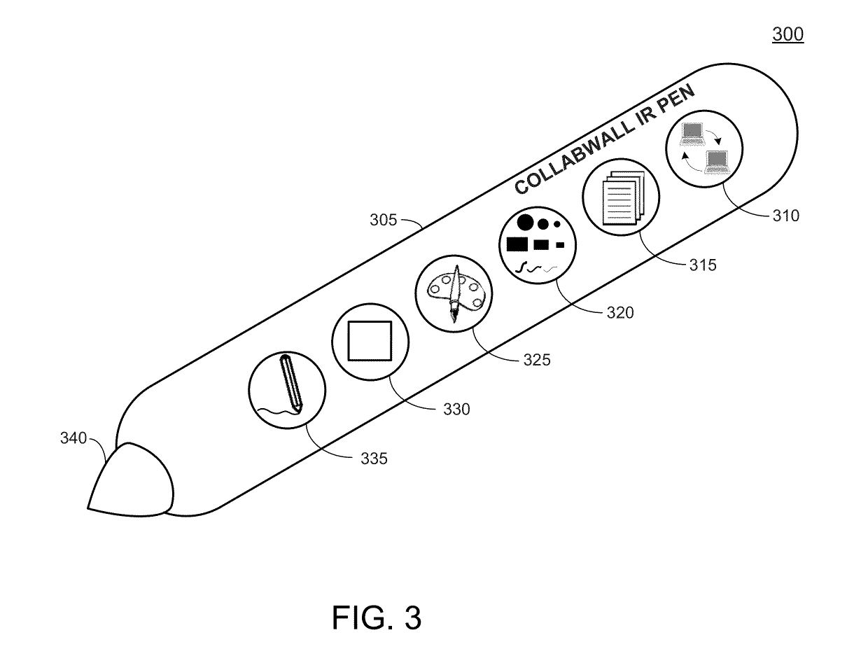

FIG. 3 depicts an exemplary Infra Red (IR) Pen according to an embodiment. Specifically, FIG. 3 depicts an IR pen 300, which consists of an IR LED 340 with a push button switch in the form factor of a pen. IR pen 300 is used as a writing instrument with the virtual whiteboard or virtual space as the medium. The whiteboard is the projected image 205 of the computer screen on the wall. In another embodiment, any flat surface may be turned into a suitable medium. The infra red light emanating from IR pen 300 and projected onto a calibrated surface creates IR points that are detected by IR sensor 1 and IR sensor 2. In one embodiment, IR pen 300 simulates the left/right click of a mouse. In another embodiment, IR pen 300 is adapted to control features of the system such as write (335), erase (325), traverse to next and previous pages (315), print (330), change colors (325), change brush sizes, allow sharing/annotation of various document types (e.g., Adobe's portable document format, Microsoft's Word, Excel, PowerPoint and other formats, JPEG, MPEG and other still or moving image formats, and so on), audio and/or video annotation in real-time and so on. To activate these functionalities, IR pen 300 would house a circuit board with the necessary logic. For example, IR pen 300 can be upgraded by downloading revised, updated and new software versions to the device. In this embodiment, IR pen 300 is adapted to communicate with the computer rather than the sensors. In one embodiment, IR pen 300 is equipped with Bluetooth to communicate with the computer. In another embodiment, IR pen 300 is equipped with WiFi. Although primarily depicted and described with respect to these two wireless technologies, it will be appreciated that other arrangements are also contemplated. Further, in this embodiment, the virtual whiteboard projected onto the wall becomes a plain white surface without the need of any controls on the calibrated area for interaction.

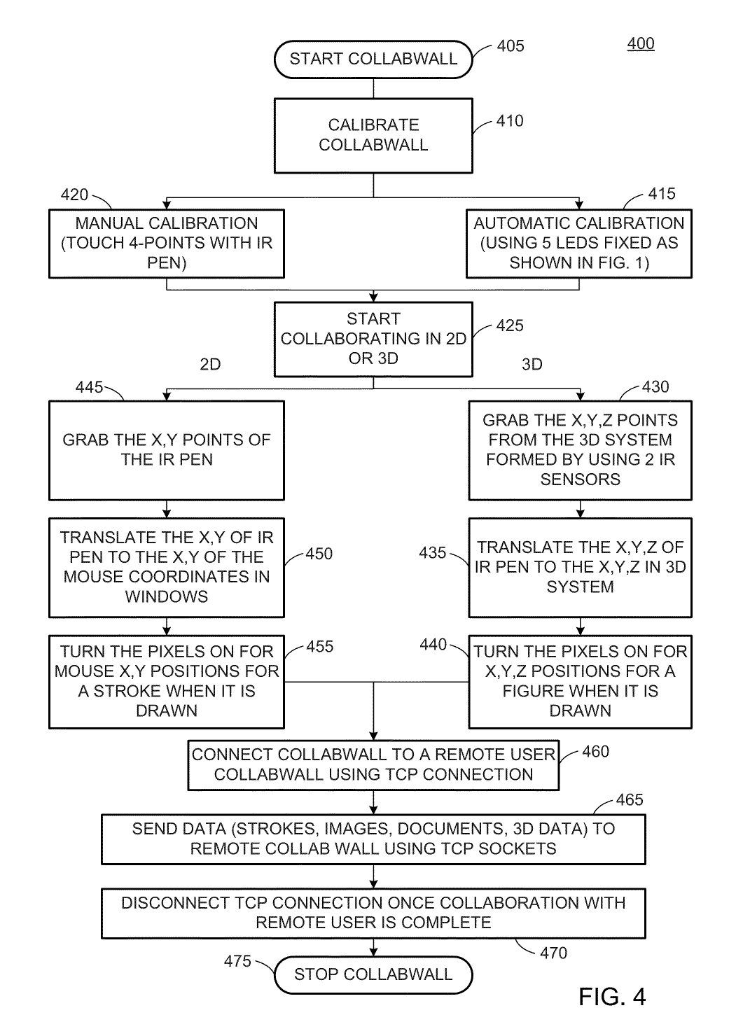

FIG. 4 depicts flow diagram of a method for system calibration and operation according to an embodiment. The method starts at step 405. At step 410, one of two options namely, Manual Calibration or Automatic Calibration is chosen. At step 415, Automatic Calibration module is executed. In one embodiment, IR LED1 (220), IR LED2 (230) and IR LED3 (240), IR LED4 (225) and IR LED5 (235) are used to calibrate the 3-dimensional x-y-z space perpendicular to the 2-dimensional x-y space. In another embodiment, other mechanisms are contemplated.

In step 420, the Manual Calibration module is executed. In this embodiment, the Touch 4-points calibration with IR pen is performed. At step 425, one of two options namely, 2-D interaction or 3-D interaction is chosen. At step 430, x, y, z points are acquired from the 3-D system formed using IR sensor 1 (210), IR sensor 2 (215). At step 435, the x-y-z points designated by the input device are translated into the x, y, z points of the 3-D system. In one embodiment, the input device is IR pen 300. Although primarily depicted and described with respect to IR pen 300 as an input device, it will be appreciated that other input devices are also contemplated. At step 440, pixels for x-y-z positions are turned on for a drawn image.

In step 445, x-y points are acquired from the input device. As indicated above, in some embodiments the input device is an IR pen while in other embodiments other input devices are also contemplated. At step 450, the acquired points are translated to the x-y of the mouse coordinates in Windows. At step 455, pixels for x-y position(s) for a stroke are turned on when the one or more positions are drawn.

In step 460, a remote user is connected to the current session using TCP connection. Although primarily depicted and described with respect to using TCP connection to connect a remote user, it will be appreciated that other schemes are also contemplated. At step 465, data in the form of strokes, images, documents, 3-D data and the like are transmitted to the remote user using TCP sockets. At step 470, the TCP connection is disconnected once collaboration with the remote user is complete. At step 475, the process ends.

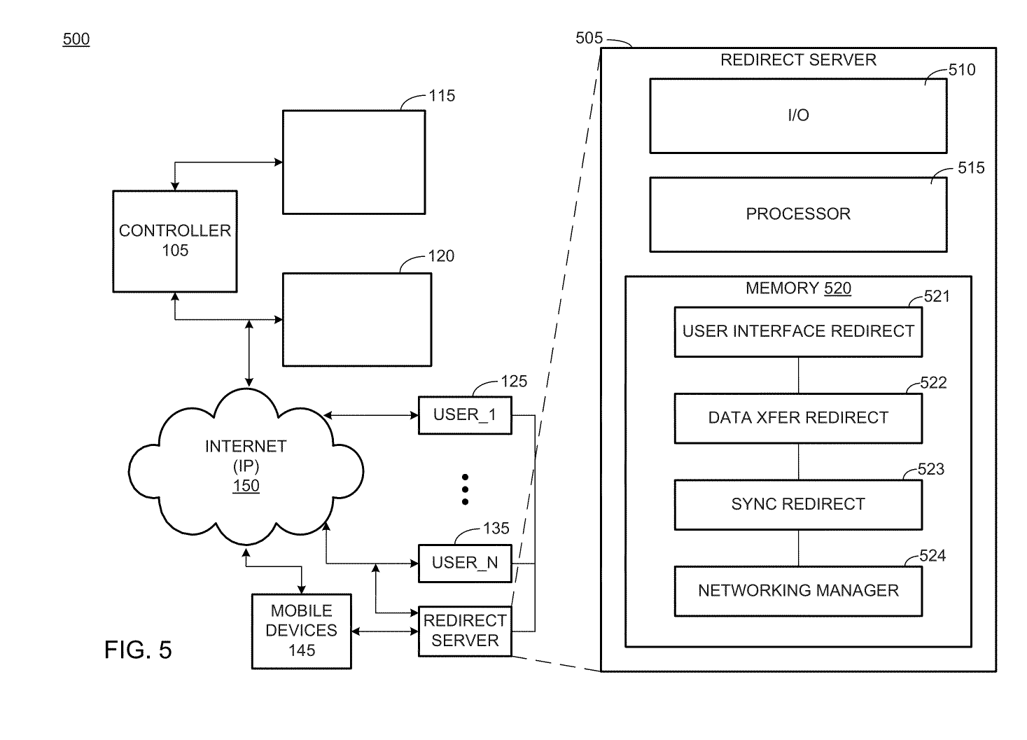

FIG. 5 depicts a high-level block diagram of an exemplary Real-time Interactive Collaborative System including a Redirect Server 505 according to an embodiment. Specifically, FIG. 5 depicts a Redirect Server 505 in communication with Controller 105. Redirect server 505 comprises includes I/O circuitry 510, a processor 515, and a memory 520. Processor 521 is adapted to cooperate with memory 520, I/O circuitry 510 to provide various publishing functions for the content publisher.

I/O circuitry 510 is adapted to facilitate communications with peripheral devices both internal and external to processor 515. For example, I/O circuitry 510 is adapted to interface with memory 520. Similarly, I/O circuitry 5106 is adapted to facilitate communications with User Interface Redirect 521, Data Transfer Redirect 522, Sync Redirect 523, Networking Manager 524 and the like. In various embodiments, a connection is provided between processor ports and any peripheral devices used to communicate with Controller 105.

Although primarily depicted and described with respect to User Interface Redirect 521, Data Transfer Redirect 522, Sync Redirect 523, Networking Manager 524, it will be appreciated that I/O circuitry 510 may be adapted to support communications with any other devices suitable for providing the computing services associated with controller 105.

Memory 520, generally speaking, stores data and software programs that are adapted for use in providing various computing functions within the Real-Time Interactive Collaborative system. The memory includes a User Interface Redirect 521, Data Transfer Redirect 522, Sync Redirect 523, Networking Manager 524.

In one embodiment, when multiple users in multiple locations are using the system, a client-server arrangement is preferred involving Redirect server 505 to perform traffic management. In this embodiment, remote users 145 in multiple locations are interconnected through Redirect server 505. As described herein, User Interface Redirect 521, Data Transfer Redirect 522, Sync Redirect 523, Networking Manager 524 are mapped to User Interface Manager 109, Data Transfer Manager 110, Sync Manager 111, Calibration Manager 112, Network Layer Manager 113 operate in conjunction with User Interface Manager 109, Data Transfer Manager 110, Sync Manager 111, Calibration Manager 112, Network Layer Manager 113 to enable data transfer between controller 105 and the various remote users.

Redirect Server 505 is an exemplary system only; other types of systems may be used within the context of the various embodiments. Other permutations are also contemplated. User 145 may be a phone, PDA, computer, or any other wireless user device.

In one embodiment, applications on mobile platforms (such as Windows, iPhone/iPad and Android) connect to the whiteboard's IP address to transfer data. In this embodiment, multiple users are connected to the whiteboard from their mobile applications. The mobile device e.g., iPad, iPhone, Android may perform certain functions on the wall. In one embodiment, the mobile device adds and deletes content, input gesture controls and the like on the wall/flat surface. In other embodiments, other functions are contemplated.

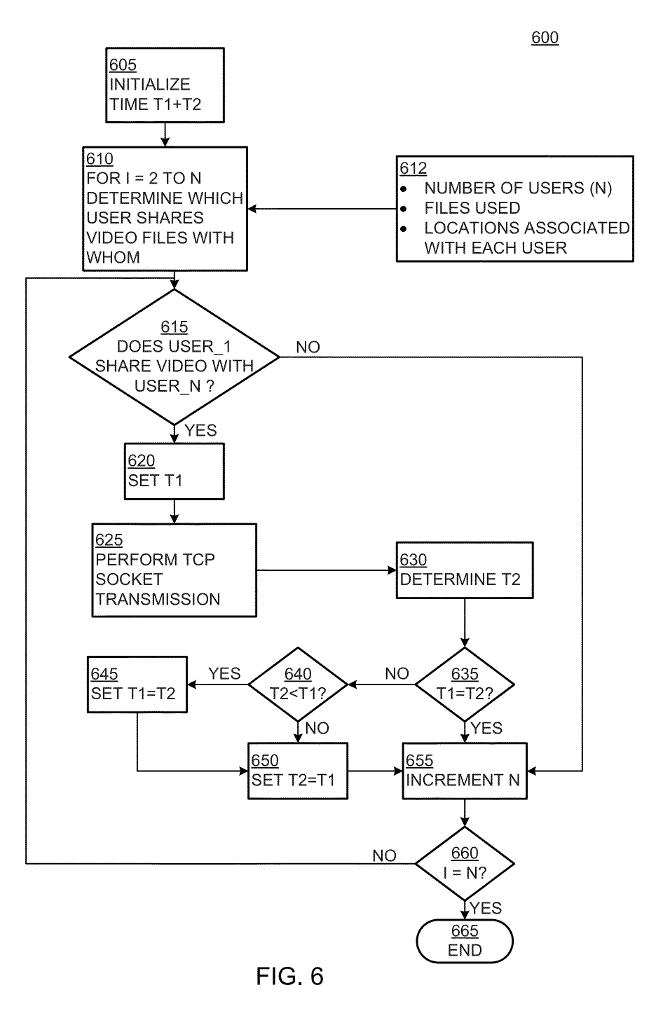

FIG. 6 depicts a flow diagram of a method for synchronizing video files according to an embodiment. The video files are transmitted to the remote user. Once the file is transferred, the users on either end can annotate the file in real time. The following algorithm is executed to ensure that the video files are shared and played synchronously on both sides. In various embodiments, the algorithms described herein are modified to send annotated documents in real-time.

At step 605, the system is initialized. T1 is a counter designated to hold the elapsed time at the first user's end (near end or sender) and T2 is the equivalent of T1 at the second user's end (far end or receiver). T1 and T2 are set to zero, i.e., T1=0 and T2=0. N represents the number of users involved in a particular session.

At step 610, the user to whom the first user shared the video with is identified. At step 615, if the first user shares a video with the second user, then step 620 is executed. If not, step 655 is executed.

At step 655, the variable N is incremented and step 660 is executed. At step 660, if the loop counter is equal to the number of users in the session then the loop ends. If not step 655 is executed. At step 620, T1 is set to the elapsed time on the video at the first user's end. At step 625, using the TCP socket, a message is transmitted to the second user with time T1=time elapsed on the video at the first user's end. At step 630, the same operation is performed at the remote end, e.g., second user's end. T2 which is the time elapsed on the video at the remote end is obtained. At step 635, T1 is tested against T2. If T1=T2, step 655 is executed. If not, step 640 is executed. If T2>T1 then step 645 is executed, if not step 650 is executed. At step 650, T2 is set equal to T1, i.e., T1=T2 and step 655 is executed. At step 645, T1 is set equal to T2, i.e., T2=T1 and again step 655 is executed.

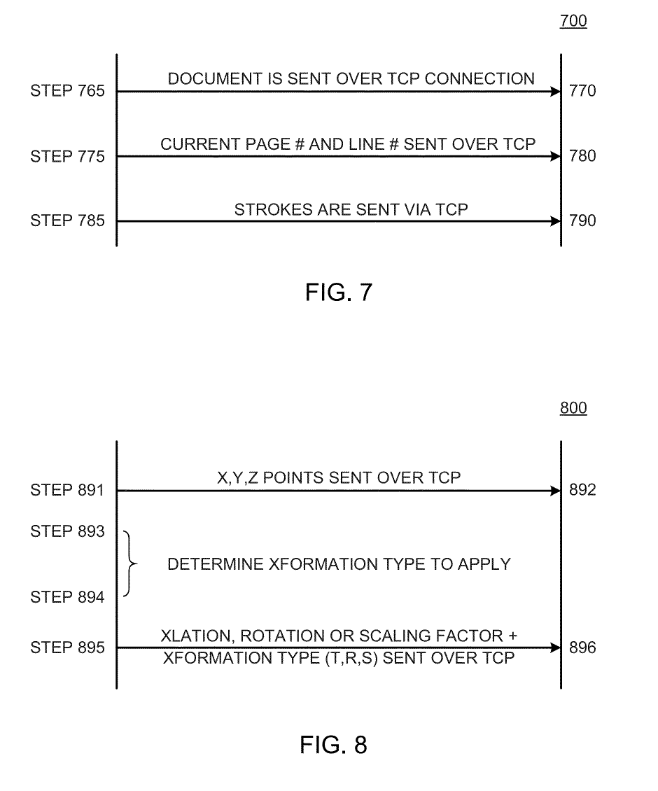

FIG. 7 depicts a flow diagram of a method for sharing documents among users with real time annotation. At step 710, User A opens the document to be shared with User B. In one embodiment, the document is forwarded toward User B over TCP connections. In other embodiments, other means of file transfer are used. At step 715, the document is opened in the virtual interactive space upon receipt. In other embodiments, User B activates the document. At step 720, the current pointer to the page number and line number are obtained. In one embodiment, the current page number and line number are forwarded toward User B over TCP connections. In other embodiments, other means of file transfer are used. At step 725, User B receives the pointers and sets the control at the received page number and line number. At step 730, a page associated with strokes is annotated in the document by writing to the virtual interactive space. In one embodiment, the strokes are forwarded toward User B over TCP connections. In other embodiments, other means of file transfer are used. At step 735, User B receives the strokes and the strokes are displayed at the current page and line number overlaid on the document.

FIG. 8 depicts a flow diagram of a method for manipulating 3D figures. At step 810, User A draws a 3-D object with corresponding x, y, z coordinates in the virtual interactive space. In one embodiment, the 3-D coordinates are forwarded toward User B over TCP connections. In other embodiments, other means of file transfer are used.

At step 815, User B receives the 3-D coordinates and displays the 3-D object in the virtual interactive space. At step 820, the applicable transformation type is determined; namely, translation, rotation or scaling. At step 830, the appropriate transformation is applied. For example, if the determined transformation type is translation, a selected translation (T) location is applied to the 3-D object to move the object to the new position. If the determined transformation type is rotation, a selected rotation angle is applied to the 3-D object to rotate the object. If the determined transformation type is scaling, a selected scaling factor (S) is applied to the 3-D object to scale the object. At step 840, the applied transformation type and the translation, rotation or scaling factor are forwarded toward User B over TCP connections. In other embodiments, other means of file transfer are used. At step 845, User B applies the type of transformation and the value of transformation to the 3-D object and displays the resulting object.

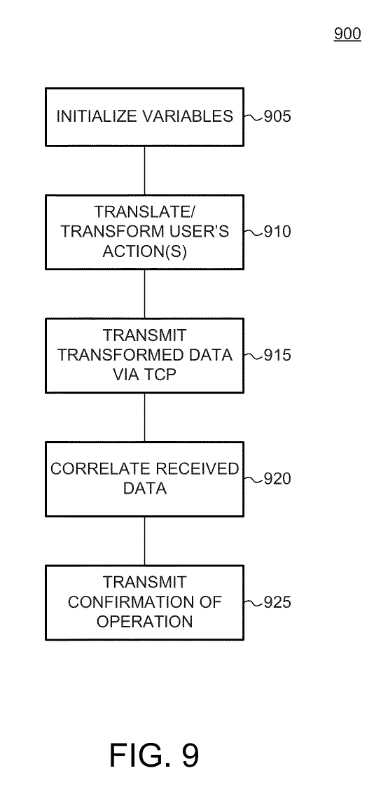

FIG. 9 depicts a flow diagram of a method for transforming of Input Device Positions according to an embodiment. One of the unique features of the Real-time Interactive Collaborative System is to apply geometric transformations to images uploaded or strokes drawn on the collaborative surface. A user on one end can upload an image or draw stroke/strokes on the wall and rotate an object by any specified angle. As a result, the image rotates on the near end and also rotates by the same angle on the far end if collaborative mode is invoked (connected by the network or are in collaboration). A user on one end can upload an image or draw stroke/strokes on the respective wall and scale the image by any factor and the image/stokes scale by that factor is replicated on the near end and the remote end if collaborative mode is invoked in real-time.

A user on one end can upload an image or draw stroke/strokes on a respective wall and translate the image by any coordinate and the image/strokes can translate to a new position on the near end and far end if collaborative mode is invoked.

At step 905, variables are initialized. In one embodiment, R1=0, R2=0, L1=0, L2=0 and S1=0, S2=0. In another embodiment, other variables are used. At step 910, when the first user wants to rotate the image/stroke by an angle, then R1 is set to the angle of rotation, i.e., R1=angle of rotation. In another embodiment, when the first user wants to scale the image/stroke by a factor, then S1 is set to that scale factor, i.e., S1=scale factor. In yet another embodiment, when the first user wants to translate the image/stroke by some points, then L1 is set to the points of translation, i.e., L1=points of translation. At step 915, the variables R1, L1 and S1 are transmitted to the far end via TCP with a header “Rotate”/“Translate”/“Scale.” At step 920, the user at the far end receives R1, L1 and S1 and set R2=R1, L2=L1 and S2=S1 and correlates “Rotate by R2”/“Translate by L2”/“Scale by S2” on the image/stroke. At step 925, the far end user sends confirmation to the near end user (sender) that rotation is complete.

The virtual interactive space contemplated by the various embodiments described herein may comprise a three dimensional space or a two dimensional space or some combination thereof.

Specifically, a three dimensional virtual whiteboard or space is generally described herein is being implemented at a local or remote location via a presentation arrangement adapted to provide imagery associated with the virtual space and an input device adapted to provide motion indicative signaling within a volume associated with the virtual interactive space. A computer or processor in communication with the presentation arrangement and the input device is programmed or otherwise adapted to propagate data representing the imagery toward one or more remote users, to receive data indicative of input device motion within the virtual interactive space, and to adapt the imagery in response to data indicative of input device motion within the virtual space.

However, in some embodiments, not all locations include a virtual whiteboard or virtual space having a volume or third dimensional component. For example, in various embodiments one or more locations (e.g., a primary location) may use apparatus providing a virtual whiteboard or virtual space having a depth or third dimension as described herein, while other locations (e.g., a mobile location) may use a simplified two dimensional virtual whiteboard or virtual space.

A two dimensional virtual whiteboard or virtual space location may comprise a computer, laptop computer, tablet and/or smartphone displaying whiteboard imagery upon a standard display device and accepting input data from a keyboard, pointing device, touch screen, voice recognition system or other input mechanism. In this case, while the volume or third dimensional components are not implemented at the two dimensional whiteboard location(s), the two dimensional whiteboard location(s) are able to interact with the three dimensional whiteboard location(s) as discussed herein.

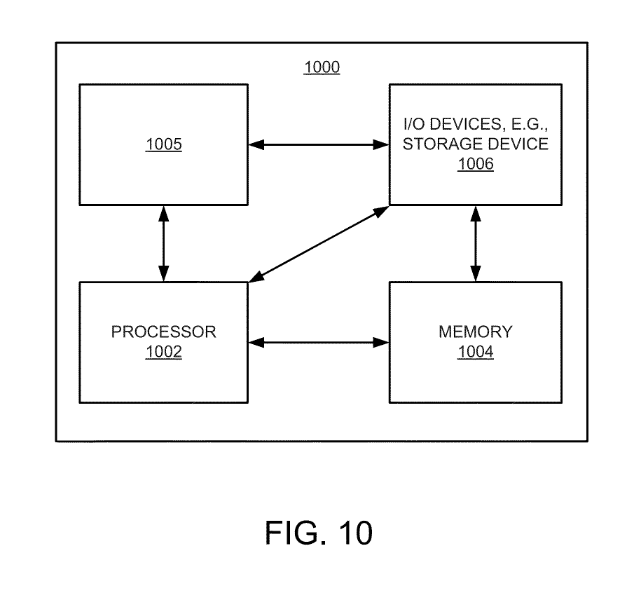

FIG. 10 depicts a high-level block diagram of a computer suitable for use in performing functions described herein.

As depicted in FIG. 10, computer 1000 includes processor element 1002 and memory 100.4 Processor element 1002 may comprise, illustratively, a central processing unit (CPU) and/or other suitable processor(s). Memory 1004 may comprise, illustratively, random access memory (RAM), read only memory (ROM) and the like.

The computer 1000 also may also include a cooperating module or process 1005, such as a hardware or software module or process adapted to perform or assist in the performance of any of the functions described herein with respect to the various embodiments.

The computer 1000 may also include any of various input and output (I/O) devices 1006. I/O devices may include by way of example a keyboard, keypad, mouse, or other user input device, a display, speaker, or other user output device, input and output ports, a transceiver, a receiver, and a tape drive, floppy drive, hard disk drive, compact disk drive, or other storage device.

It will be appreciated that the functions depicted and described herein may be implemented in software (e.g., via implementation of software on one or more processors) and/or hardware (e.g., using a general purpose computer, one or more application specific integrated circuits (ASIC), and/or any other hardware equivalents).

It will be appreciated that the functions depicted and described herein may be implemented in software for executing on a general purpose computer (e.g., via execution by one or more processors) so as to implement a special purpose computer, and/or may be implemented in hardware (e.g., using one or more application specific integrated circuits (ASIC) and/or one or more other hardware equivalents).

In one embodiment, the cooperating process 805 can be loaded into memory 1004 and executed by processor 1002 to implement functions as discussed herein. Thus, cooperating process 1005 (including associated data structures) can be stored on a computer readable storage medium, e.g., RAM memory, magnetic or optical drive or diskette, and the like.

It will be appreciated that computer 1000 depicted in FIG. 10 provides a general architecture and functionality suitable for implementing functional elements described herein and/or portions of functional elements described herein. For example, computer 1000 provides a general architecture and functionality suitable for implementing one or more of multimedia server 120, a portion of multimedia server 120, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. An apparatus, comprising:
a presentation arrangement adapted to provide imagery associated with a virtual interactive space;
an input device adapted to provide motion indicative signaling within a volume associated with the virtual interactive space; and
a processor in communication with the presentation arrangement and the input device, the processor adapted to propagate data representing said imagery toward one or more remote users, to receive data indicative of input device motion within the virtual interactive space, and to adapt said imagery in response to said data indicative of input device motion within the virtual interactive space.

2. The apparatus of claim 1, wherein said virtual interactive space is defined by a presentation surface upon which imagery is displayed, and a subset of the virtual interactive space proximate the presentation surface within which input device motion is identified.

3. The apparatus of claim 2, wherein said presentation surface is defined by a plurality of infra-red (IR) light emitting diodes (LEDs) disposed thereon.

4. The apparatus of claim 3, wherein said subset of the virtual interactive space proximate the presentation surface is defined by at least one additional IR LED disposed a distance d from the presentation surface.

5. The apparatus of claim 4, further comprising a plurality of IR sensors adapted to receive motion indicative signals from one or more input devices.

6. The apparatus of claim 1, comprising a multimedia streaming device adapted to provide streaming multimedia content to a remote end.

7. The apparatus of claim 1, wherein the presentation system comprises an interactive whiteboard.

8. The apparatus of claim 1, wherein the input device further comprises an Infra Red (IR) pen adapted to simulate a mouse.

9. The apparatus of claim 4, wherein the processor communicates with said IR sensors and is adapted to automatically calibrate at least portions of said virtual interactive space.

10. The apparatus of claim 1, wherein the IR pen is adapted to designate one or more multidimensional locations and characterize multidimensional strokes within the multidimensional virtual interactive space.

11. The apparatus of claim 8, wherein the IR pen is adapted to control advanced features associated with the multidimensional virtual interactive space.

12. The apparatus of claim 1, wherein the one or more remote users comprise mobile nodes (MNs).

13. The apparatus of claim 12, wherein at least some of the MNs are enabled to provide gesture input in response to user interaction.

14. The apparatus of claim 13, wherein said user interaction comprises any of physical motion of the MN, manipulation of a MN touch screen, or manipulation of a MN keyboard.

15. The apparatus of claim 13, wherein said MN input if provided via wireless network.

16. The apparatus of claim 13, wherein said MN input supplements any IR pen input.

17. The apparatus of claim 13, wherein at least some of the MNs are enabled to add or delete content on the multidimensional virtual interactive space.

18. The apparatus of claim 1, wherein multimedia content associated with a session is transmitted to a remote end.

19. The apparatus of claim 14, wherein the multimedia content is synchronized when presented at the remote end.

20. The apparatus of claim 4, wherein said processor is adapted to calibrate the presentation service by sequentially activating IR LEDs mounted thereon to generate a difference in pixel positions, read the difference in pixel positions using the IR sensors, and map the difference in pixel positions to a physical distance to thereby define a two-dimensional portion of the virtual interactive space.

21. A method, comprising:
defining a presentation surface of a virtual interactive space using a plurality of plurality of infra-red (IR) light emitting diodes (LEDs) disposed thereon, and defining a volume proximate the presentation surface using at least one additional IR LED disposed a distance d from the presentation surface, wherein imagery associated with the virtual interactive is displayed upon the presentation surface; and
adapting displayed imagery in response to data indicative of input device motion within virtual interactive space.

22. A computer readable medium for storing software instructions which, when executed by a processor, adapt the operation of the processor to perform a method, comprising:
defining a presentation surface of a virtual interactive space using a plurality of plurality of infra-red (IR) light emitting diodes (LEDs) disposed thereon, and defining a volume proximate the presentation surface using at least one additional IR LED disposed a distance d from the presentation surface, wherein imagery associated with the virtual interactive is displayed upon the presentation surface; and
adapting displayed imagery in response to data indicative of input device motion within virtual interactive space.

23. A computer program product, wherein a computer is operative to process software instructions which adapt the operation of the computer such that the computer performs a method, comprising:
defining a presentation surface of a virtual interactive space using a plurality of plurality of infra-red (IR) light emitting diodes (LEDs) disposed thereon, and defining a volume proximate the presentation surface using at least one additional IR LED disposed a distance d from the presentation surface, wherein imagery associated with the virtual interactive is displayed upon the presentation surface; and
adapting displayed imagery in response to data indicative of input device motion within virtual interactive space.
